(19) United States
(12) Patent Application Publication
(10) Pub. No.: US 2025/0251848 A1
(43) Pub. Date: Aug. 7, 2025

(54) MULTI-DEVICE SESSION TRANSFER AND AI-BASED IDENTITY VERIFICATION USING VISUAL INPUT IN CONVERSATIONAL INTERFACES

(71) Applicant: CELLIGENCE INTERNATIONAL LLC, Guaynabo, PR (US)

(72) Inventors: Pavan AGARWAL, Dorado, PR (US); Gabriel Albors SANCHEZ, San Juan, PR (US); Jonathan Ortiz RIVERA, San Juan, PR (US)

(73) Assignee: CELLIGENCE INTERNATIONAL LLC, Guaynabo, PR (US)

(21) Appl. No.: 19/188,971

(22) Filed: Apr. 24, 2025

Related U.S. Application Data
(63) Continuation-in-part of application No. 18/135,703, filed on Apr. 17, 2023.
(60) Provisional application No. 63/332,205, filed on Apr. 18, 2022.

(51) Int. Cl. G06F 3/0484; G06F 9/451

(52) U.S. Cl. CPC G06F 3/0484; G06F 9/451

(57) ABSTRACT

A system and method are provided for secure, AI-driven session transfer between devices using visual input and behavioral authentication. A user may use a mobile device to capture an image or video of another device's screen, including live streams, video calls, or form sessions. The system detects and classifies actionable interface content from the captured media and initiates a secure session handoff or mirroring workflow to the capturing device. The system further uses AI to verify user identity based on historical behavioral patterns and conversational interaction style. Secure hyperlinks, masking logic, and persistent session context are maintained throughout the transfer. The system enables seamless, privacy-conscious transfers of digital sessions across devices using camera-based detection and behavioral AI.

### RELATED APPLICATIONS

This application a continuation-in-part of U.S. patent application Ser. No. 18/135,703, filed on Apr. 17, 2023, which claims the benefit of U.S. Provisional Application No. 63/332,205 filed on Apr. 18, 2022, the contents of which are incorporated herein by reference in its entirety.

### FIELD

The present disclosure relates to systems and methods for secure, AI-assisted digital interaction workflows. More specifically, it relates to transferring active sessions and content across devices using camera-based visual detection and AI-driven user verification. The system supports multi-device session transfer, visual content detection, and identity validation based on behavioral interaction patterns and session context history.

### BACKGROUND

Existing systems for conversational workflows and digital form completion frequently assume a single-device context and rely heavily on text-based input or rigid graphical interfaces. While some platforms offer web-based chat tools or SMS-based interactions, users often encounter friction when attempting to continue an interaction across multiple devices-especially in scenarios involving real-time media, video calls, or screen-specific content.

Modern user behavior frequently involves transitioning between devices in fluid contexts: capturing a form from a desktop screen using a smartphone, resuming a Zoom session mid-interaction, or transferring content from a browser tab to a secure mobile environment. Current platforms lack native support for visually-driven session transfers, relying instead on brittle copy-paste mechanisms, QR codes, or insecure cross-device links.

Moreover, traditional security and authentication systems focus on static credentials or out-of-band verification, which are poorly suited for fast, camera-triggered transitions. They do not account for contextual cues like behavioral consistency or conversational fingerprinting that could provide lightweight yet robust identity verification across sessions.

Accordingly, there is a need for systems that enable users to initiate secure, AI-assisted transfers of content, sessions, or interactions by simply pointing a mobile device at another screen. These systems should support real-time visual content-including Zoom calls, video streams, and interactive forms- and incorporate AI-driven user verification based on historical patterns. Such capabilities would enhance usability, preserve continuity, and improve security for multi-device digital interactions.

### SUMMARY

The present disclosure extends upon previously filed systems for AI-driven SMS mirroring and conversational form workflows by introducing enhanced multi-device live chat transfer capabilities. In particular, the system enables a user to initiate a secure interaction transfer between devices—such as from a desktop interface to a mobile device—by using a mobile device's camera to visually capture the content on another screen.

A visual detection module processes the captured media, including images, live streams, video calls, and screen content (e.g., Zoom sessions), using a combination of optical character recognition (OCR), image classification, and AI-based interaction recognition. The system identifies actionable regions or session contexts and triggers secure session mirroring or handoff based on the captured content.

In addition, the system introduces AI-powered user authentication based on behavioral signals. Specifically, user identity may be verified using historical answer patterns and interaction styles across sessions. These security features can operate in parallel with camera-based live session transfers to ensure continuity and privacy across modalities.

The enhanced system maintains persistent session state, synchronizes form data, and provides secure links and mirrored views between devices. The disclosed features improve usability for users switching devices mid-session, facilitate secure onboarding in video-assisted environments, and offer adaptive identity verification without requiring password entry or multi-step authentication processes.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIGS. 1A-1C illustrate a conversational application session transfer and security system, according to an implementation of the disclosure.

FIG. 2 is a flowchart illustrating a user interaction and workflow example, according to an implementation of the disclosure.

FIG. 3 illustrates an example computing system that may be used in implementing various features of embodiments of the disclosed technology.

Described herein are systems and methods for enabling secure, multi-device interaction and session transfer using a conversational AI interface integrated with visual and behavioral inputs. The system facilitates dynamic handoff and mirroring of active sessions—including form completion workflows, video calls, or live content—across devices by leveraging visual detection from a device camera. A machine learning-powered AI assistant (AA) guides users through these interactions by analyzing screen-captured media, identifying actionable content, and triggering structured data synchronization. Modular components support camera-based screenpoint recognition, session persistence, behavioral identity verification, and real-time synchronization between mobile and web interfaces. In some embodiments, a human assistant (HA) may be engaged when system confidence is low or user behavior indicates elevated friction. Technical details of example embodiments—including multi-device interaction logic, AI-driven session restoration, and visual content processing workflows—are set forth below. Additional features, objects, and advantages will be apparent to those skilled in the art upon examination of the following description, illustrative examples, and accompanying claims.

### DETAILED DESCRIPTION

The disclosed system enables secure, AI-assisted transfer of active conversational sessions—such as chats, form interactions, or live video calls—between devices using visual and behavioral input across multiple devices. The system supports dynamic session transfer, including scenarios where a mobile device equipped with a camera captures the screen of a desktop or laptop device to initiate a secure session handoff. This enables seamless transitions mid-session and allows users to resume interactions—such as chat, form filling, or video conferencing—without repeating steps or logging in through conventional authentication flows. By identifying interface context visually and authenticating the user based on historical behavioral patterns, the system eliminates the need for manual login or session restart, preserving continuity across platforms.

Conventional systems lack the ability to seamlessly resume sessions across devices without disrupting the user experience or re-entering data. For example, users who begin a workflow on a laptop may want to continue on a mobile device without logging in or repeating prior steps. Traditional solutions rely on cookies, account-based authentication, or manual handoff, none of which support real-time, AI-assisted, camera-based session recovery. The disclosed system addresses this limitation by allowing a mobile device to visually detect and claim an ongoing session with AI-powered screenpoint recognition and secure resumption protocols.

Additionally, the system supports behavioral identity verification using historical interaction patterns such as prior answers, timing, phrasing, or preferences. This AI-based approach enables the system to infer user identity in a lightweight, privacy-respecting manner. The result is a more flexible, intuitive experience that adapts to users across devices and modalities—including passive media, active forms, and synchronous or asynchronous chat workflows.

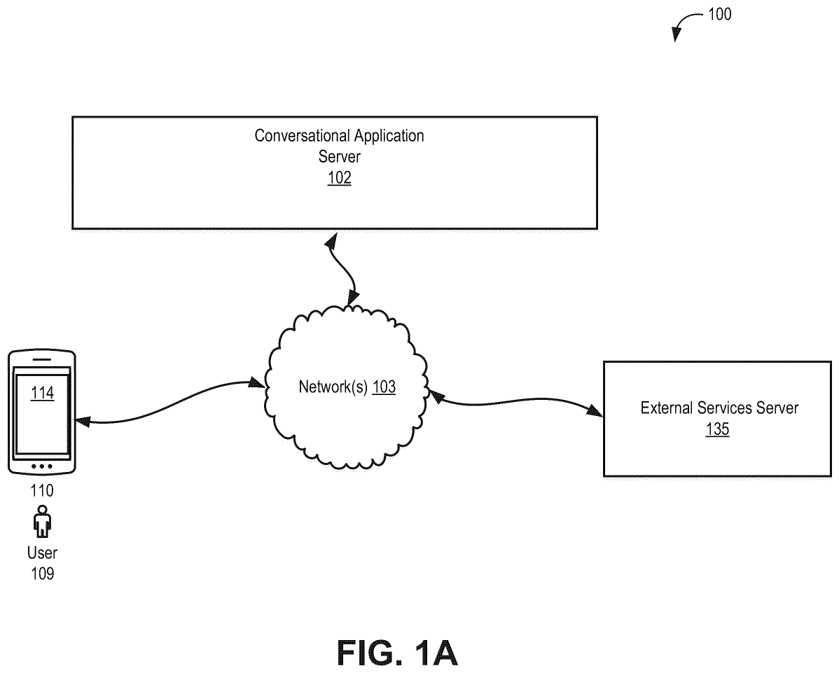

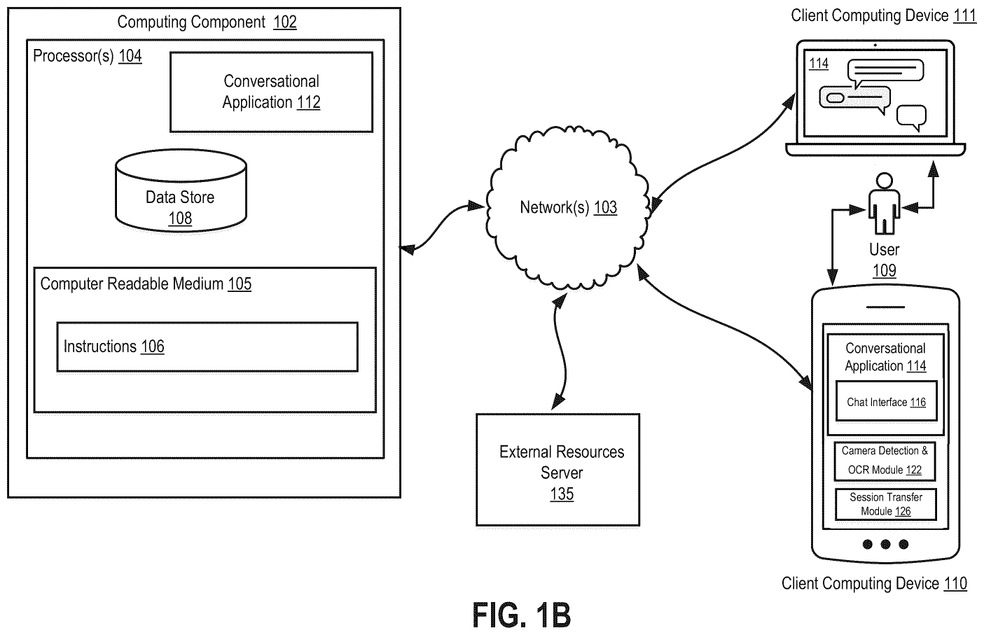

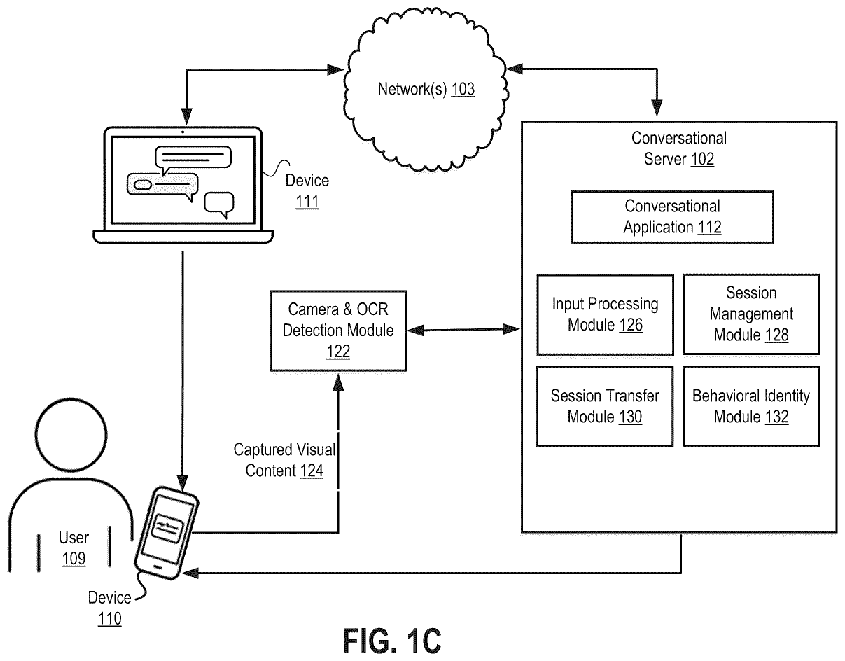

The presently disclosed conversational application session transfer and security system, includes a distributed architecture with one or more backend servers executing conversational logic, a mobile client device with camera-based detection capabilities, and an optional desktop or secondary device serving as the original session context. The system includes a server-side conversational application, a mobile computing device with a camera, and an optional second device displaying an active session. The system supports visual detection and session capture, behavioral authentication, and bidirectional synchronization. Furthermore, the system facilitates AI-assisted processing, while the mobile device executes modules such as a camera detection and OCR module 122, an input processing module 126, a session transfer module 130, and a behavioral identity module 132, as shown in FIG. 1C.

The methods and techniques disclosed herein produce several technical effects and advantages, including seamless session resumption across devices with secure session mobility and identity verification without login credentials, context-aware, camera-initiated handoff, behavioral user verification without passwords, and session synchronization for dynamic content ranging from chat to video and forms resulting in and adaptive user experience across devices.

A key feature of the system is its ability to detect and initiate session transfer using a camera-equipped mobile device. When a user points a mobile device at the screen of another device (e.g., a laptop or desktop computer or another mobile device), the system uses computer vision and OCR to identify key interface elements (e.g., chat window, video stream, or form UI). A server-assisted engine analyzes this input to determine the session context and generate a transfer command.

Once context is confirmed, the mobile device receives session data and restores the interaction in a compatible interface—such as a mirrored chat window or synchronized video stream. This transfer occurs without requiring the user to log in or search for prior activity.

To secure the session transfer, the system includes a behavioral authentication module that verifies user identity based on historical interaction patterns. These may include phrasing style, response timing, UI preferences, or engagement frequency. This module helps determine whether the mobile user is the same as the one previously active on the scanned device.

The use of behavioral identity modeling reduces reliance on conventional login credentials while enhancing session security. In certain implementations, behavioral confidence thresholds may trigger fallback mechanisms such as QR code verification or optional passcodes.

The system includes an optional escalation pathway to a Human Assistant (HA) when conversational flow is interrupted, or confidence scores fall below threshold. The HA may receive a summary of the user's prior responses and current session status to provide seamless support.

The system preserves session state during transfer, including unstructured chat messages, form field values, and media content. Mirrored interfaces across devices are synchronized bidirectionally, allowing the user to pick up exactly where they left off.

The system supports multiple modalities including web-based chats, video conferencing tools, passive video streams, and interactive form workflows. It enables fluid handoffs between interfaces, maintaining session continuity across device types and interface formats.

FIG. 1A illustrates an exemplary conversational application session transfer and security system 100, in accordance with the embodiments disclosed herein. The system 100 includes multiple components configured to enable the secure transfer, resumption, and synchronization of conversational sessions—such as form workflows, chat-based interactions, or video calls—across devices. The system facilitates camera-based screen detection, AI-driven behavioral identity verification, and dynamic interface synchronization.

The system 100 includes a conversational application server 102, which communicates over network 103 with one or more external services servers 135 and client computing devices 110-111. A user 109 may accesses the system through a client computing device 110, such as a mobile phone equipped with a camera, or a secondary device 111, such as a desktop or laptop computer. In some embodiments, session content originates on device 111 and is transferred to device 110 using visual detection or QR code scanning. Each device may run a version of conversational application 114 or support interaction through a web interface. Server 102 performs backend processing to support conversational workflows, context synchronization, and security operations.

As illustrated in FIG. 1B, the server 102 includes processor(s) 104 configured to execute the conversational application 112 stored in memory. The application 112 may include one or more modules for session management, data extraction, behavioral identity verification, and multi-device synchronization. The application accesses a data store 108 containing conversational models, user interaction history, and session state information. Processor 104 executes instructions 106 from a computer-readable medium 105 to manage conversational flows, detect user intent, and facilitate secure session transitions.

The conversational application 112 enables natural language interactions between users and the system, including form guidance, video session control, and chat-based communication. Application 112 ensures synchronization between multiple interfaces (e.g., chat and GUI), and supports transfer of session context between devices based on visual cues or QR code scans. The system may classify user input, select appropriate workflows, and enable dynamic context restoration based on the interaction stream.

As shown in FIG. 1B, computing component or server 102 may be implemented as a server computer, controller, or similar component capable of managing distributed communication with client devices. In the illustrated implementation, computing component 102 includes a processor 104 configured to execute instructions residing in a machine-readable medium 105 that includes computer program components used to manage session continuity, secure communication, and identity verification.

Hardware processor 104 may be one or more central processing units (CPUs), semiconductor-based microprocessors, and/or other hardware devices suitable for retrieval and execution of instructions stored in computer readable medium 105. Processor 104 may fetch, decode, and execute instructions 106, to control processes or operations for automatically categorizing tasks and assigning color. As an alternative or in addition to retrieving and executing instructions, hardware processor 104 may include one or more electronic circuits that include electronic components for performing the functionality of one or more instructions, such as a field programmable gate array (FPGA), application specific integrated circuit (ASIC), or other electronic circuits.

A computer readable storage medium, such as machine-readable storage medium 105 may be any electronic, magnetic, optical, or other physical storage device that contains or stores executable instructions. It may store instructions for behavioral modeling, session tracking, screenpoint recognition, or visual decoding for OCR. Medium 105 enables persistent logic execution and contextual recall necessary for seamless multi-device session transitions. Computer readable storage medium 105 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 105 may be a non-transitory storage medium, where the term “non-transitory” does not encompass transitory propagating signals. As described in detail below, machine-readable storage medium 105 may be encoded with executable instructions, for example, instructions 106.

Client computing device 110 serves as the primary interface for user 109 to engage with the form optimization system. The device runs a local instance of the conversational AI-driven form optimization application 114, which includes both a chat interface 116 and a graphical user interface (GUI) 118 for form visualization and interaction. Through this interface, the user may input responses to AI-generated questions, review the auto-populated form, and optionally edit data fields.

Client computing device 110 serves as a mobile device operated by user 109 and provides the interface for capturing screen content from another device. This device may run a local instance of the conversational application (e.g., 114) and includes a camera used to visually detect screen content from client device 111. Device 111 may be a laptop, desktop, or other computing device where the original session (e.g., a form workflow or video call) is active. Device 110 supports modules such as a camera detection & OCR module 122, an input processing module 126, a session management module 128, a session transfer module 130, an AI-driven behavioral identity verification module 132, and a QR code scanner module, as illustrated in FIGS. 1B-1C.

The chat interface 116 supports intuitive, dialogue-based interactions with the AI assistant, while GUI interface 118 displays dynamic content such as forms, workflows, or mirrored interfaces from another device. Both interfaces are synchronized such that user input through one interface updates the other in real time.

The system may operate in a hybrid mode with a Conversational AI Assistant (AA) executing locally on device 110/111 or remotely via server 102. The AA guides users through workflows, interprets natural language input, and facilitates form filling, document collection, or session recovery. Escalation to a Human Assistant (HA) may occur when user input indicates elevated friction or ambiguity.

In some embodiments, components of the conversational application may be distributed across the server and client devices. For instance, modules such as camera detection & OCR module 122, input processing module 126, a session management module 128, a session transfer module 130, an AI-driven behavioral identity verification module 132, and (optionally) a QR code scanner module, may operate partially on client device 110 and partially via cloud coordination with server 102.

In some embodiments, input processing module 126 interprets OCR-derived screen context and parses semantic indicators from the image, session management module 126 maps the parsed screen data to an existing or pending session instance, session transfer module 130 coordinates restoration of the session onto device 110 by transmitting UI state, conversation history, and synchronization metadata, and behavioral identity module 128 evaluates historical response patterns, timing, phrasing, and behavioral signals to verify that the mobile user is the same user previously active on device 111.

In some embodiments, the conversational AI Assistant may operate as part of the broader conversational application 112, supporting natural language processing, visual handoff detection, and behavioral profile analysis. The platform supports session continuity across devices and may facilitate intelligent identity verification based on historical response patterns.

A specific embodiment of application 112 may be tailored for dynamic form selection, field synchronization, and guided form completion. For example, a specialized form optimization application 112 may be configured to guide structured form completion. However, Application 112 may also support generic chat, third-party chat mirroring, video conferencing environments, and hybrid workflows.

In some embodiments, the session may originate from a third-party application, such as a video conferencing tool or live streaming platform. The system may capture and resume interactive sessions such as a Zoom call, Google Meet session, or similar conferencing environment, using visual detection and behavioral context mapping to preserve continuity across devices.

The AI assistant may interact with users through client device 110 and facilitate multi-modal interaction, including typing, clicking, or camera-based actions.

The system may guide the user through form workflows or session recovery, using conversational logic to generate prompts, collect structured data, and update mirrored sessions. AI logic may reside in application 112 or be provided through integration with external services.

During use, the AI assistant may generate prompts based on ongoing interaction, detect skipped or conflicting data, and initiate session updates in the GUI. Real-time form progression, data validation, and autofill operations may be guided through conversational flow.

In some implementations, voice interaction may be supported in addition to chat. The system may use synthesized voices to distinguish AI and human participants, enabling users to complete workflows verbally. Voice responses are transcribed and routed to the assistant for classification and processing.

The assistant continuously monitors user interaction signals such as delay, tone, or repeated clarification requests. If user behavior suggests confusion or friction, the system may adjust phrasing, introduce simpler prompts, or summarize progress.

Predictive models trained on historical workflows may be used to generate follow-up suggestions, preempt user drop-off, and reinforce user intent. These may include prompts to complete missing fields, confirm prior entries, or transition to a related workflow.

If a session exceeds defined friction thresholds, the assistant may escalate to a human assistant (HA) without interrupting flow. Handoff includes context summaries and pre-processed insights to allow seamless agent transition. The system may provide HAs with AI-generated suggestions tailored to user behavior, previous answers, and likely areas of confusion. These enhancements improve consistency and efficiency across automated and human-assisted sessions.

FIG. 1C illustrates the visual and backend workflow of the conversational application session transfer and security system 100, focusing on two primary session transfer pathways: (1) visual screen detection using a mobile camera, and (2) QR code scanning. FIG. 1C shows how visual inputs from a mobile device are processed and used to locate and resume an active session on another device, such as a desktop or laptop.

For example, a multi-device session transfer initiated by a user pointing a camera-equipped mobile device 110 at a desktop or laptop screen of device 111 by user 109. The desktop 111 may be displaying a chat interface, live stream, video call, or other real-time session. As illustrated in FIG. 1B, the mobile device 110 runs a conversational application 114.

In one embodiment, the mobile device 110 includes a camera detection and OCR module 122 configured to capture and analyze screen content. This module applies computer vision techniques—such as object detection, feature extraction, and visual classification—to identify UI elements (e.g., chat windows, messages, control regions) and determine their on-screen positions.

In some embodiments, module 122 performs object detection and feature recognition to identify screen elements of interest, such as message bubbles, chat windows, or interactive regions. Object detection and classification may be used to compute the (x, y) coordinates of the centroid of identified elements within the screen image, allowing the system to determine which portion of the interface the user is referencing. In some embodiments, OpenCV's scale-invariant feature transform (SIFT) is used to extract robust visual keypoints for UI recognition. This positional data may then be correlated to a known screenpoint within the session interface, enabling accurate session mapping and transfer. This screenpoint data is passed forward to input processing module 126 for semantic interpretation and session context resolution.

This distinction allows the system to efficiently manage early-stage capture and deeper UI understanding as separate but coordinated phases of the visual handoff process.

In another embodiment, the system may alternatively use the QR code scanner module (not illustrated), which supports scanning both static QR images and dynamic video streams to capture session tokens or deep links. These QR codes may encode session identifiers, URLs, or contextual metadata that allow the mobile device to locate and resume a specific session.

Camera-based session detection enables session transfer by analyzing a live view of the screen on device 111. This approach provides flexibility when a QR code is not available but requires significant computational effort. The mobile device must capture unstructured screen input and apply computer vision techniques—such as object detection, keypoint matching, and UI layout parsing—to identify actionable content. The extracted data must then be mapped to a known session, often using behavioral cues. This process typically involves identity verification using models trained on historical input patterns, ensuring secure access without requiring manual credentials.

In contrast, QR code scanning is a more lightweight and direct method. The QR code encodes structured information such as a session ID or token, which the mobile device decodes instantly. Upon scanning, the mobile device sends the decoded payload to the server, which maps it directly to a previously established session context. No computer vision processing or UI analysis is required, and identity verification may be embedded in the token or handled via simpler fallback mechanisms.

The QR-based approach is typically faster and more reliable when a QR code is present, while the camera-based approach is more flexible in unstructured environments. Both pathways ultimately converge on the same backend session restoration flow but differ significantly in how the initial session context is acquired and verified.

This dual-path architecture allows the system to adapt to varying user conditions and device environments, balancing speed and robustness depending on available inputs and interface constraints.

Once a valid visual context is recognized, the camera & OCR detection module 122 transmits captured visual content 124 to the conversational server 102 via network 103. The server executes a conversational application 112, which includes the following key backend modules: input processing module 126, session management module 128, session transfer module 130, and behavioral identity module 132 and/or other such modules.

The input processing module 126 receives the structured visual content and interprets it to identify screen layout and relevant conversational context. For example, the module 126 may extract screen text, layout markers, and semantic indicators. It may perform parsing and semantic analysis of detected features, determine session type, and filter ambiguous or redundant regions. The parsed output is forwarded to the session management module 128.

The session management module 128 identifies the relevant session context by matching the extracted content with known sessions or active workflows. For visual handoffs, the session transfer module 130 performs screenpoint resolution to identify the specific thread, form, or chat window captured by the user. It then retrieves the corresponding session state.

The session transfer module 130 transmits the recovered session data—including interface elements, message history, and dynamic UI state—to mobile device 110. Upon receipt, the conversational application 114 on mobile device 110 renders the corresponding conversational interface, resuming the interaction from the same point as it appeared on device 111.

To ensure secure handoff, the behavioral identity module 132 verifies the user's identity based on historical interaction signals, such as phrasing patterns, response timing, or navigation habits. This AI-driven behavioral analysis enables session restoration without requiring manual login credentials.

As a fallback or alternate workflow, the QR code scanner module may be used to initiate session recovery. Upon scanning, the system loads the corresponding session context directly from the server and restores it on mobile device 110, bypassing the need for camera-based detection.

Through the integrated use of the camera & OCR detection module 122, input processing module 126, session management module 128, session transfer module 130, behavioral identity module 132, and optionally a QR code scanner module, the system performs visual detection, QR-based recovery, session mapping, and identity verification. These capabilities enable seamless, AI-assisted session continuity across devices—without requiring explicit login, manual navigation, or user reauthentication.

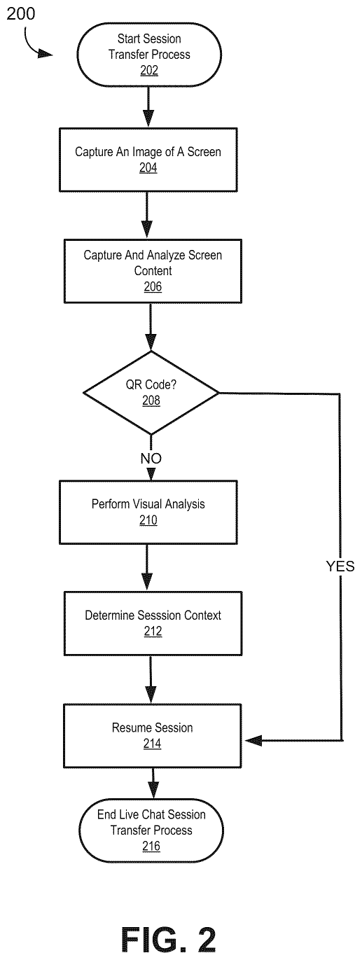

With reference now to FIG. 2, a flowchart illustrating an exemplary session transfer workflow is shown in accordance with an embodiment of the conversational application session transfer and security system 100. This process supports seamless transfer of a live or interactive session—such as a chat, video stream, or guided workflow—from one device to another (e.g., from a desktop to a mobile phone), using either camera-based screen detection or QR code scanning. The illustrated steps are executed primarily by components such as the camera detection and OCR module 122, input processing module 126, and session transfer module 130 described in FIGS. 1B-1C.

The process begins at step 202 when the user initiates the session transfer process, typically from the mobile device. In step 204, the mobile device captures a visual image or live frame of the screen on a second device (e.g., a laptop displaying the original session).

Step 206 performs initial analysis of the captured screen content to determine whether a QR code is present. At decision step 208, the system evaluates whether a QR code was successfully detected. If a QR code is found, the flow proceeds directly to step 212 where the session context is resolved from the scanned data, and then to step 214 where the session is resumed. If no QR code is detected, the system continues to step 210, where the mobile device performs deeper visual analysis to identify and classify UI elements from the captured image.

In step 212, the system determines the session context using positional data, semantic interpretation, and screenpoint resolution.

Once the session is resolved, step 214 resumes the session on the mobile device. The workflow concludes at step 216 when the session transfer is completed, and the user is engaged with the resumed session in the conversational interface.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in

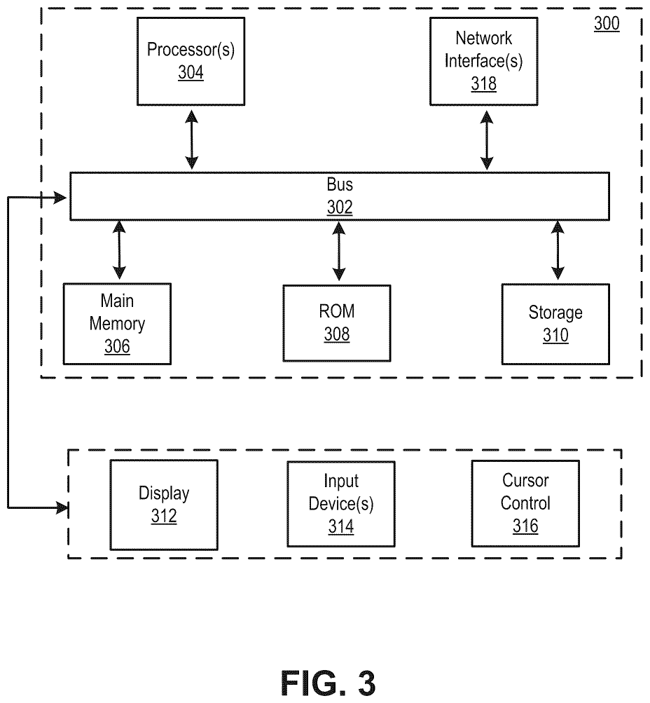

FIG. 3. Various embodiments are described in terms of this example computing module 300. After reading this description, it will become apparent to a person skilled in the relevant art how to implement the technology using other logical circuits or architectures.

FIG. 3 illustrates an example computing module 300, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAS, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 3. Various embodiments are described in terms of this example-computing module 300. After reading this description, it will become apparent to a person skilled in the relevant art how to implement the application using other computing modules or architectures.

Referring now to FIG. 3, computing module 300 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 300 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 300 might include, for example, one or more processors, controllers, control modules, or other processing devices, such as a processor 304. Processor 304 might be implemented using a general-purpose or special-purpose processing engine such as, for example, a microprocessor, controller, or other control logic. In the illustrated example, processor 304 is connected to a bus 302, although any communication medium can be used to facilitate interaction with other components of computing module 300 or to communicate externally. The bus 302 may also be connected to other components such as a display 312, input devices 55, or cursor control 316 to help facilitate interaction and communications between the processor and/or other components of the computing module 300.

Computing module 300 might also include one or more memory modules, simply referred to herein as main memory 306. For example, preferably random-access memory (RAM) or other dynamic memory might be used for storing information and instructions to be executed by processor 304. Main memory 306 might also be used for storing temporary variables or other intermediate information during execution of instructions to be executed by processor 304. Computing module 300 might likewise include a read only memory (“ROM”) 308 or other static storage device 310 coupled to bus 302 for storing static information and instructions for processor 304.

Computing module 300 might also include one or more various forms of information storage devices 310, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 310 might include other similar instrumentalities for allowing computer programs or other instructions or data to be loaded into computing module 300. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 300.

Computing module 300 might also include a communications interface or network interface(s) 318. Communications or network interface(s) interface 318 might be used to allow software and data to be transferred between computing module 300 and external devices. Examples of communications interface or network interface(s) 318 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 318 might typically be carried on signals, which can be electronic, electromagnetic (which includes optical) or other signals capable of being exchanged by a given communications interface. These signals might be provided to communications interface 318 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 306, ROM 308, and storage unit interface 310. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 300 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method for transferring a live session from a first device to a second device, the method comprising:
capturing, by the second device, a visual input of a screen displayed on the first device;
analyzing the visual input to detect a user interface (UI) element associated with an active session;
determining, based on the detected UI element, session context information associated with the active session;
transmitting, from the second device to a server, the session context information;
receiving, at the second device, session data associated with the active session from the server; and
resuming the session on the second device using the session data.

2. The computer-implemented method of claim 1, wherein capturing the visual input comprises activating a camera on the second device and capturing one or more image frames of the first device's display.

3. The computer-implemented method of claim 1, wherein analyzing the visual input comprises performing object detection and keypoint extraction to identify the UI element.

4. The computer-implemented method of claim 3, further comprising computing a centroid coordinate of the UI element and mapping the coordinate to a screenpoint in the active session.

5. The computer-implemented method of claim 1, further comprising verifying the identity of a user of the second device based on behavioral interaction patterns associated with prior sessions.

6. The computer-implemented method of claim 1, wherein the second device determines that the visual input includes a QR code and, in response, decodes the QR code to retrieve the session context information.

7. The computer-implemented method of claim 1, wherein decoding the QR code bypasses the need for object detection and UI analysis.

8. The computer-implemented method of claim 1, wherein resuming the session comprises launching a conversational interface on the second device and rendering a view of the session at the same state as displayed on the first device.

9. The computer-implemented method of claim 1, further comprising storing a history of prior user interactions and using the history to disambiguate session context from the visual input.

10. The computer-implemented method of claim 1, wherein the session comprises a real-time chat, video stream, form-filling interface, or guided workflow.

11. A system for transferring a session from a first device to a second device, the system comprising:
a camera on the second device configured to capture a visual input of a screen displayed on the first device;
a camera detection and OCR module configured to analyze the visual input to detect a user interface (UI) element associated with an active session;
an input processing module configured to interpret the detected UI element and determine session context information;
a session management module configured to identify the session based on the session context information;
a session transfer module configured to transmit session data associated with the session to the second device; and
a conversational application on the second device configured to resume the session based on the session data.

12. The system of claim 11, wherein the camera detection and OCR module is further configured to perform object detection and keypoint analysis to identify the UI element.

13. The system of claim 12, wherein the camera detection and OCR module is further configured to compute a centroid of the UI element and generate a screenpoint coordinate.

14. The system of claim 11, wherein the input processing module is further configured to disambiguate between multiple UI regions and select a most likely session context using positional and semantic indicators.

15. The system of claim 11, further comprising a behavioral identity module configured to verify the identity of a user of the second device based on prior interaction history.

16. The system of claim 11, wherein the camera detection and OCR module is further configured to detect a QR code in the visual input and extract session context encoded in the QR code.

17. The system of claim 16, wherein the session transfer module is configured to bypass visual analysis when the QR code is detected and decoded.

18. The system of claim 11, wherein the session data includes one or more of: interface layout, conversation history, form completion progress, or video playback position.

19. The system of claim 11, wherein the conversational application on the second device comprises a chat interface, a split-screen form view, or a video playback interface.

20. The system of claim 11, wherein the session comprises an interactive chat, video conference, real-time stream, or form-based user interface.
